(19) United States
(12) Patent Application Publication
(10) Pub. No.: US 2011/0106977 A1
(43) Pub. Date: May 5, 2011

(54) METHOD AND SYSTEM FOR HOST INDEPENDENT SECONDARY APPLICATION PROCESSOR

(76) Inventors: Hemal Shah, Trabuco Canyon, CA (US); Simon Assouad, Irvine, CA (US); Vinod Lakhani, Laguna Niguel, CA (US)

(21) Appl. No.: 12/908,269

(22) Filed: Oct. 20, 2010

Related U.S. Application Data
(60) Provisional application No. 61/258,180, filed on Nov. 4, 2009.

(51) Int. Cl. G06F 15/16

(52) U.S. Cl. 709/250

(57) ABSTRACT

A network interface controller (NIC) in a computer device may provide host-independent secondary processing servicing. The secondary processing servicing may be provided by the NIC independent of networking operations performed by NIC, and may comprise performing applications and/or services typically performed in the computer device. The secondary processing servicing may be provided, and/or be activated when an operating system (OS), a virtual machine (VM), a service, and/or an application running in the computer device becomes unavailable, due to transitions to non-active and/or low-power or power saving states. In instances where the computer device is configured as a virtualized platform, comprising a plurality of VMs, the secondary processing servicing may be provided separately and/or independently to each of the plurality of VMs running in the computer device during the virtualization. The secondary processing servicing may be provided using a dedicated component in the NIC, which may be fixed or removable.

### CROSS-REFERENCE TO RELATED APPLICATIONS/INCORPORATION BY REFERENCE

This patent application makes reference to, claims priority to and claims benefit from U.S. Provisional Application Ser. No. 61/258,180 filed on Nov. 4, 2009. This application also makes reference to:

U.S. Provisional Application Ser. No. 61/230,363 filed on Jul. 31, 2009;
U.S. application Ser. No. 12/845,343 filed on Jul. 28, 2010; and
U.S. application Ser. No. 12/758,975 filed on Apr. 13, 2010.

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to audio processing. More specifically, certain embodiments of the invention relate to a method and system for host independent secondary application processor.

### BACKGROUND OF THE INVENTION

A computer system or computer device may be utilized to receive inputs, store and process data, and provide outputs for various applications. A computer system or computer device such as, for example, a desktop PC, a laptop PC, a notebook PC, a server, a workstation, a mobile computing device or other computing platform may comprise a network interface controller (NIC). The NIC may be coupled internally or externally to the computer system. The NIC may be utilized in network access operations, to enable sending and/or receiving data via wired and/or wireless connections.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for a host independent secondary application processor, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary computer system that may support secondary processing services via a network controller, in accordance with an embodiment of the invention.

FIG. 2A is a block diagram illustrating an exemplary computer system that may support secondary processing servicing of a host environment comprising a single OS, in accordance with an embodiment of the invention.

FIG. 2B is a block diagram illustrating an exemplary computer system that may support secondary processing servicing of a host environment comprising a plurality of virtual machines, in accordance with an embodiment of the invention.

FIG. 3 is a flow chart that illustrates exemplary steps for providing host-independent secondary processing via a network controller, in accordance with an embodiment of the invention.

### DETAILED DESCRIPTION OF THE INVENTION

Certain embodiments of the invention may be found in a method and system for a host independent secondary application processor. In various embodiments of the invention, a network controller in a computer device may provide a host-independent secondary execution environment, which may enable running and/or executing a plurality of applications and/or services independently in the network controller. The secondary processing environment may be provided by the network controller independent of networking operations performed by network controller, and may comprise performing applications and/or services typically performed in the computer device. Exemplary services that may be provided by the secondary execution environment may comprise management services, application synchronization services, storage access services, multimedia services, network proxy services, location services, and/or security services. The computer device may comprise a personal computer (PC), a server, a workstation, and/or a mobile computing device. The secondary execution environment may be provided when an operating system (OS), a virtual machine (VM), a service, and/or an application running in the computer device becomes unavailable, which may result in error from system, OS, and/or VM transitions to non-active and/or low-power states. The secondary execution environment may be activated when the corresponding OS, the VM, the service, and/or the application becomes unavailable.

In instances where the computer device is configured as a virtualized platform, which may be operable to concurrently execute a plurality of virtual machines (VMs), the secondary execution environment may be provided separately and/or independently to each of the plurality of virtual machines (VMs) running in the computer device during the virtualization. This may be done with and/or without awareness by the secondary execution environment of the virtualization. In instances where the secondary execution environment operates based on awareness of the virtualization, tasks may be scheduled and/or managed on a per-VM basis. The secondary execution environment may be provided using a dedicated component in the network controller. The dedicated component may be fixed or removable.

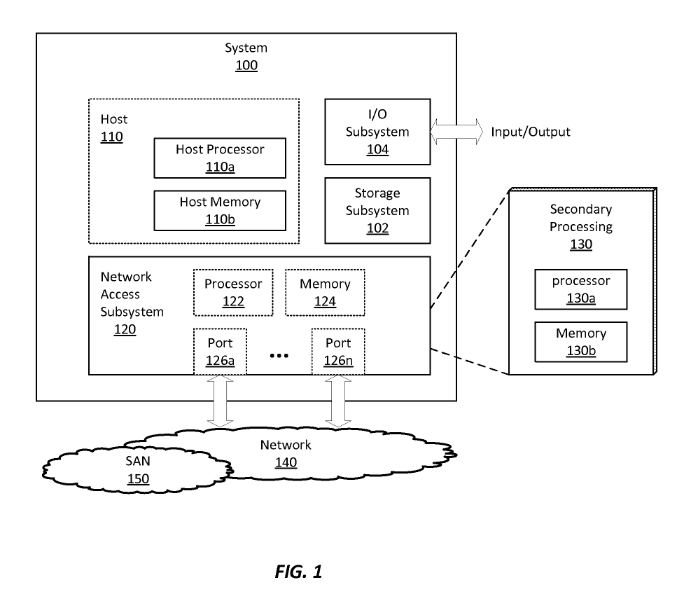

FIG. 1 is a block diagram illustrating an exemplary computer system that may support secondary processing services via a network controller, in accordance with an embodiment of the invention. Referring to FIG. 1, there is shown a computer system 100, a storage subsystem 102, an input/output (I/O) subsystem 104, a host 110, and a network access subsystem 120. Also shown in FIG. 1 are an external network 140 and a storage area network (SAN) 150.

The computer system 100 may comprise suitable logic, circuitry, interfaces, and/or code that may be operable to perform various tasks and/or execute applications, based on preloaded instructions and/or user input for example. The computer system 100 may comprise, for example, a desktop personal computer (PC), a laptop, a notebook, a workstation, a server, and/or a handheld mobile computing device. The computer system 100 may comprise the host 110, the storage subsystem 102, the I/O subsystem 104, and/or the network access subsystem 120. In this regard, the host 110 may perform various tasks and/or applications in the computer system 100, and/or may provide overall control and/or management of the operations of the computer system 100. The I/O subsystem 104 may enable user interactions with the computer system 100. The network access subsystem 120 may enable communication of data and/or messages from and/or to the computer system 100, when executing various tasks and/or applications. The computer system 100 may also comprise other hardware resources (not shown), such as a graphics card and/or a sound card for example, which may be internal or peripheral components.

The storage subsystem 102 may comprise suitable logic, circuitry, interfaces and/or code that enable permanent and/or non-permanent storage and/or fetching of data, code and/or other information used in the computer system 100. In this regard, the storage subsystem 102 may comprise different storage devices, including, for example, read-only memory (ROM), random access memory (RAM), Flash memory, solid-state drive (SSD) and/or field-programmable gate array (FPGA) devices. The storage subsystem 102 may store, for example, configuration data, which may comprise parameters and/or code, comprising software and/or firmware, but the configuration data need not be limited in this regard.

The I/O subsystem 104 may comprise suitable logic, circuitry, interfaces, and/or code that may enable inputting and/or outputting data, messages, and/or commands, to support user interactions with the computer system 100, to receive user input, provide user output, and/or to enable content play and/or display operations. For example, the I/O subsystem 104 may facilitate interactions with the computer system 100 via one or more I/O devices (not shown), such as a mouse, keyboard, a monitor, and/or audio speakers.

The host 110 may correspond to components and/or subsystems in the computer system 100, which may be used for running and/or executing processes, tasks, services and/or applications that may be provided to users of the computer system 100, for example. In this regard, the host 110 may comprise one or more dedicated or general processors 110a (e.g. CPU), one or more memories 110b. The host processor 110a may comprise suitable logic, circuitry, interfaces and/or code that may be operable to process data, and/or control and/or manage operations of the host 110, and/or tasks and/or applications performed therein. In this regard, the host processor 110a may be operable to configure and/or control operations of various components and/or subsystems of the host 110, by utilizing, for example, one or more control signals. The host processor 110a may also control data transfers within the host 110. The host processor 110a may enable execution of applications, programs and/or code, which may be stored in the host memory 110b, for example. The host processor 110a may also be operable to control and/or manage operations of the computer system 100 as a whole, and/or other components or subsystems therein, to support application and/or tasks provided by the host 110 for example.

The host memory 110b may comprise suitable logic, circuitry, interfaces and/or code that enable permanent and/or non-permanent storage and/or fetching of data, code and/or other information used in the computer system 100. In this regard, the host memory 110b may comprise one or more ROM, RAM, Flash, SSD, and/or FPGA storage devices. While the host memory 110b is shown as a separate entity from the storage subsystem 102, the invention is not so limited. Accordingly, the memory 110b may comprise a dedicated device and/or portion thereof in the storage subsystem 102 that may be allocated to support operations of the host 110.

The network access subsystem 120 may comprise suitable logic, circuitry, interfaces, and/or code that may be operable to communicate data and/or messages from and/or to the computer system 100. The network access subsystem 120 may comprise, for example, a network interface controller or card (NIC). The network access subsystem 120 may comprise, for example, the networking processor 122, the networking memory 124, and/or the plurality of ports 126a-126n. The networking processor 122 may comprise suitable logic, circuitry, interfaces, and/or code for controlling and/or managing operations of the network access subsystem 120. The networking memory 124 may comprise suitable logic, circuitry, interfaces and/or code for dedicated local storage and/or buffering of data within the network access subsystem 120. In this regard, the networking memory 124 may comprise one or more ROM, RAM, Flash, SSD, and/or FPGA devices. Each of the plurality of ports 126a-126n may comprise suitable logic, circuitry, interfaces, and/or code for providing network interfacing functionality, in the network access subsystem 120, based on one or more networking standards and/or protocols. The plurality of ports 126a-126n may comprise, for example, 10 GbE ports. The network access subsystem 120 may support and/or perform, for example, physical (PHY) layer related access, via the plurality of ports 126a-126n, and/or processing therefor. The network access subsystem 120 may also support and/or perform Media Access Control (MAC) layer related processing (e.g. addressing and/or channel access) corresponding to one or more supported networking standards. In this regard, exemplary network standards may comprise wired based standards, such as Ethernet, Digital Subscriber Line (DSL), Integrated Services Digital Network (ISDN), and/or Fiber Distributed Data Interface (FDDI); or wireless standards, such as WLAN (IEEE 802.11). The network access subsystem 120 may also perform some switching, such as layer 2 (L2) based switching for example, during transmission and/or reception of data packets. The switching supported by the network access subsystem 120, however, need not be limited to L2, and may comprise L2, L3, L4, VLAN, and/or other protocol layers.

In an exemplary embodiment of the invention, the network access subsystem 120 may provide a secondary processing environment in the computer system 100. In this regard, the network access subsystem 120 may comprise a secondary processing component 130, which may comprise suitable logic, circuitry, interfaces, and/or code that may be operable to provide secondary execution environment in the computer system 100 that may operate independent of the host 110. The secondary processing component 130 may be fixed, and accordingly, it may be integrated into the network access subsystem 120, and/or it may be removable, and accordingly, it may be a card-like device that may be inserted into, for example, a PCI-based slot in the network access subsystem 120. The secondary processing component 130 may comprise, for example, a secondary processor 130a and a secondary memory 130b. The secondary processor 130a may comprise suitable logic, circuitry, interfaces and/or code that may be operable to perform, run, and/or execute tasks, applications, and/or services which may typically be performed by other components in the computer system 100, such as the host 110 for example. In this regard, the secondary processor 130a may be operable to control and/or manage operations of other components and/or subsystems, trigger and/or control data transfers, process data, and/or execute code and/or instructions stored in, for example, the secondary memory 130b. The secondary memory 130b may comprise suitable logic, circuitry, interfaces and/or code that enable permanent and/or non-permanent storage and/or fetching of data, code and/or other information used by the secondary processing component 130. While the secondary processor 130a and the secondary memory 130b are shown as separate entities within the secondary processing component 130, the invention need not be so limited. For example, the secondary processor 130a and/or the secondary memory 130b may correspond to, and/or functions or operations described herein with respect to the processor 130a and/or the secondary memory 130b, may be performed by other components of the network access subsystem 120, such as the networking processor 122 and/or the networking memory 124, respectively, for example.

The network 140 may comprise a system of interconnected networks and/or devices which may enable exchange of data and/or messages among a plurality of nodes, based on one or more networking standards, including, for example, Internet Protocols (IP). The network 140 may comprise a plurality of broadband capable subnetworks, which may comprise, for example, satellite networks, cable networks, DVB networks, the Internet, and/or other local or wide area network. These subnetworks may collectively enable conveying data, via Ethernet packets for example, to plurality of end users. In this regard, physical connectivity within, and/or to or from the network 140, may be provided via copper wires, fiber-optic cables, wireless interfaces, and/or other standards-based interfaces. The SAN 150 may comprise one or more remote storage resources. In this regard, the SAN 150 may comprise network storage devices, which may be remotely accessed and/or utilized (for storage) by other network devices, such the computer system 100, wherein the storage devices of the SAN 150 may be presented as locally attached storage resources to operating systems (OS) and/or virtual machines (VMs) running in the network devices. The computer system 100 may obtain external networking connectivity, via the network switching system 120 for example, to access and/or utilize the network 140 and/or the SAN 150.

In operation, the host 110 may be operable to provide services, and/or to execute applications and/or processes in the computer system 100. In this regard, some of the applications and/or processes executed by the host 110 may be triggered and/or controlled by, and/or may require user input and/or output, which may be received and/or provided via the I/O subsystem 104, for example. The computer system 100 may communicate data and/or messages corresponding to services and/or applications performed via the host 110, via the network access subsystem 120 for example. In this regard, data and/or messages communicated between the computer system 100 and the network 140 and/or the SAN 150 may be transmitted and/or received, for example, via network links, which may be configured through one or more of plurality of ports 126a-126n.

In an exemplary aspect of the invention, the network access subsystem 120 may provide secondary processing environment in the computer system 100. In this regard, the secondary processing component 130 may be utilized to configure a secondary execution environment in the computer system 100, which may enable running, performing, and/or executing tasks and/or programs. For example, the secondary execution environment may be utilized to run and/or execute applications and/or services, which may need to remain available regardless of the state of the computer system 100, and/or any components thereof such as the host 110. This may ensure that minimal functionality and/or accessibility in the computer system 100 may remain available in instances where the host 110 may become unavailable. An exemplary unintended scenario when the host 100 may become unavailable may occur when the operating system (OS) running in the host 110 is hung due to an error. An exemplary intended scenario when the host 100 may become unavailable is when the host 110 transitions the OS to inactive state. Accordingly, applications and/or services provided by the secondary execution environment may be run and/or executed in lieu of and/or independent from operations of the host 110. This may enable transitioning some components and/or subsystems of the computer system 100, such as the host 110 and/or portions thereof to states, which may enable saving power for example, where at least some of the applications and/or services otherwise provided may become unavailable. Accordingly, the secondary processing environment may be available in all system states independently from, for example, user applications that may run on the host processor 110a, for example.

The secondary processing environment may be operable to control and/or configure components and/or subsystems in the computer system 100, and/or devices and/or peripherals coupled to the computer system 100. Furthermore, application data and execution consistency between applications running on the host 110 and on the secondary processing component 130 may be maintained, in a manner transparent to system users. The secondary processing environment may be managed independently from other components of the computer system 100, such as the host 110, which may typically be utilized in running, performing and/or executing similar tasks, applications, and/or services. In this regard, the secondary processor 130a may be utilized to manage and/or control operations of the secondary execution environment provided by the secondary processing component 130.

In an exemplary embodiment of the invention, the computer system 100 may be configured as a virtual platform. In this regard, the host processor 110a may be utilized, for example, to run a plurality of virtual machine (VMs) in the host 110, rather than running a single operating system (OS). Furthermore, a hypervisor may be run and/or be used, via the host processor 110a for example, to support operations of the VMs in the computer system 100. In this regard, the hypervisor may be used to enable at least some of the VMs to interact with some of the physical resources in the computer system 100. Accordingly, the secondary execution environment provided by the network access subsystem 120 may be configured to account for the virtualization of the computer system 100. In this regard, the secondary processing component 130 may be utilized to run, perform, and/or execute tasks, applications and/or services in lieu of and/or independent of serviced VMs in the host 110. Furthermore, the secondary processing component 130 may be operable to provide these services concurrently and/or separately to the plurality of VMs running in the host 110.

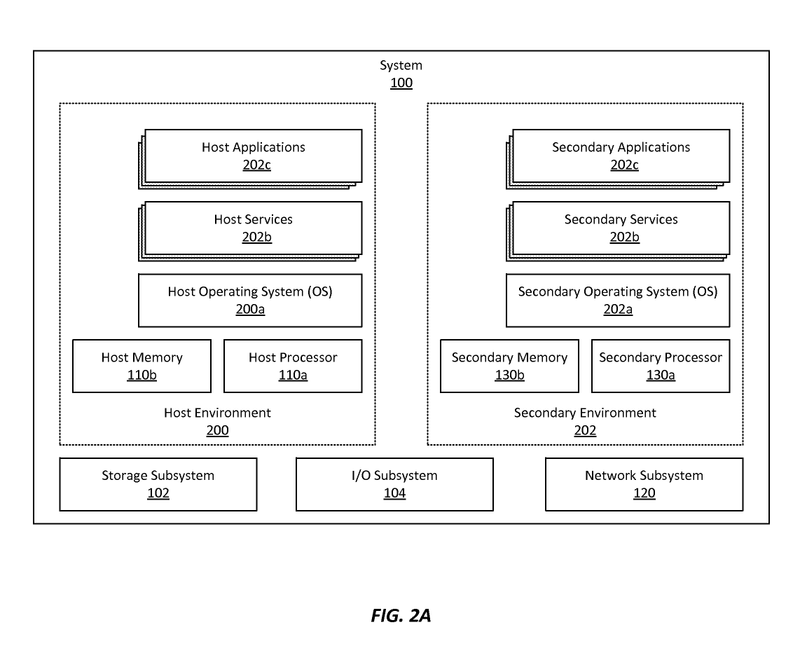

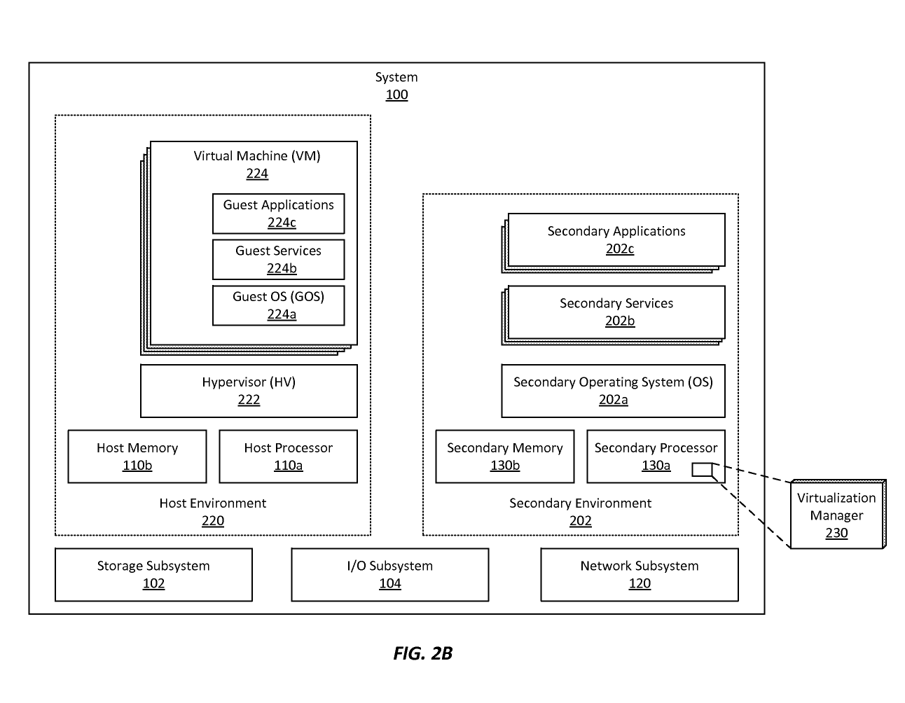

FIG. 2A is a block diagram illustrating an exemplary computer system that may support secondary processing servicing of a host environment comprising a single OS, in accordance with an embodiment of the invention. Referring to FIG. 2A, there is shown the computer system 100 of FIG. 1.

The computer system 100 may be configured as a dual execution environment system, comprising a host execution environment 200 and a secondary execution environment 202, each of which may run independent from the other. In this regard, the host execution environment 200 may be setup and/or configured in the host 110, using host processor 110a and/or the host memory 110b for example. The secondary execution environment 202 may be setup and/or configured in the secondary processing component 130 of the network access subsystem 120, using the secondary processor 130a and/or the secondary memory 130b for example. The storage subsystem 102, the I/O subsystem 104, and the network access subsystem 120 may be accessed and/or used by the host execution environment 200 and the secondary execution environment 202. In this regard, the storage subsystem 102, the I/O subsystem 104, and/or the network access subsystem 120, or any components and/or portions thereof, may be shared between the host execution environment 200 and the secondary execution environment 202, and/or may be allocated to only one of the two execution environments.

In operation, the host execution environment 200 may be setup and/or configured as a single operating system (OS) based environment. In this regard, the host execution environment 200 may comprise a single host operating system (OS) 200a, which may be utilized to support a plurality of host services 200b and/or host applications 200c. The host OS 200a may comprise software or code that may enable running and/or executing programs and/or applications, using one or more processors for example, and/or interactions with the hardware resources in the computer system 100 to facilitate running and/or executing these programs and/or applications. The host OS 200a may comprise a proprietary or open-source operating system, and may comprise various components that may support specific applications and/or services, and may enable interacting with specific types of hardware resources, such as the storage subsystem 102, the I/O subsystem 104, and/or the network access subsystem 120, and/or any devices therein. The host OS 200a may be operable to provide various services 200b and/or execute various applications 200c in the computer system 100, such as, for example, software applications, email server operations, exchange server operations, database services, networking services, and/or interfacing services (e.g. supporting use of APIs and/or GUIs).

The secondary execution environment 202 may be configured as a single operating system (OS) environment. In this regard, the secondary execution environment 202 may comprise a secondary operating system (OS) 202a, which may be utilized to support a plurality of secondary services 202b and/or a plurality of secondary applications 202c, which may be run and/or executed independent of operations of the host execution environment 200. The secondary OS 202a may be substantially similar to the host OS 200a. In this regard, the secondary OS 202a may comprise various software components that may support applications and/or services provided by the secondary execution environment 202, and may enable interacting with specific types of hardware resources, such as the storage subsystem 102, the I/O subsystem 104, and/or the network access subsystem 120.

In an exemplary aspect of the invention, the secondary execution environment 202 may be configured to provide applications and/or services that may ensure that the computer system 100 remains accessible. For example, the secondary execution environment may provide services and/or applications ensuring that the computer system 100 may remain accessible in instances where the host execution environment 202, and/or other resources in the computer system 100 such as the storage subsystem 102, the I/O subsystem 104, and the network access subsystem 120, may become unavailable. In this regard, the unavailability may result from transitioning the computer system 100, and/or portions thereof, to low-power and/or power-saving states. Exemplary low-power and/or power-saving states may comprise disabling, shutting down, and/or reducing power consumption components and/or resources transitioning to these states. For example, in instances where the host execution environment 200 may transition to low-power or power-saving state, the host processor 110a may be shut down and/or disabled, and consequently the host OS 200a, host services 200b, and/or host applications 200c may not be running. Accordingly, the secondary applications 202c and/or the secondary services 202b may comprise applications and/or services that may be used in lieu of and/or independently from corresponding applications and/or services in the host execution environment 200. In this regard, the secondary applications 202c may comprise one or more applications that may be run, performed, and/or executed independently in the secondary execution environment 202, independent from and/or regardless of availability of the host execution environment 200. For example, the secondary applications 202c may comprise email applications to enable retrieving email messages sent to users of the computer system 100.

The secondary services 202b may comprise one or more services that may be run and/or be executed in the secondary execution environment 202 independent of host execution environment 200. The secondary services 202b may be utilized, for example, to ensure that the computer system 100 remains accessible, secure, and/or ready for reactivation when necessary. For example, the secondary services 202b may comprise a management service, an application synchronization service, a storage access service, a multimedia service, a network proxy service, a location service, and a security service.

The management service may allow the overall computer system 100 to be configured, managed, monitored, and controlled independently from the system state and status and/or availability of the host execution environment 200. For example, in instances where the computer system 100 may transition to power-saving states, the management service may be used to monitor, control, diagnose, repair, and/or reconfigure the various physical and/or logical components of the computer system 100. Exemplary physical and/or logical components of the computer system 100 may comprise the host execution environment 200, the storage subsystem 102, the I/O subsystem 104, the network access subsystem 120, and/or any devices therein.

The application synchronization service may be used to ensure that context and data consistency is maintained between host applications 200c and the secondary applications 202c, when the host applications 200c are not running or are unavailable for example. Furthermore, the application context/data maintained by the secondary execution environment 202 may be synchronized with the host applications 200c when they are running in the host execution environment 200. For example, in instance where the host applications 200c comprise email applications, the application synchronization service may retrieve latest emails for a user when the host execution environment 200 is shut down. When the email application is executed in the host execution environment 200, after the host execution environment 200 transitions back to active state for example, the application synchronization service may synchronize with the email application running on the host execution environment 200. This may provide the latest application context and data without requiring the host execution environment 200 to be connected on the network.

The storage access service may be used to provide access to storage resources in the computer system 100, such as the storage subsystem 102 and/or portions thereof, independently from the host execution environment 200 and/or states of the computer system 100. Data accessed using the storage access service may comprise data used by the host execution environment 200, or data that is completely managed by remote users and/or applications that may access the computer system 100 via the network 140. in other words, the storage access service may ensure that storage operations in the computer system 100 may remain accessible, locally and/or remotely, even in instances where the host execution environment 200 may be offline and/or unavailable. The host execution environment 200 may be offline and/or unavailable, such as in instances when the host OS 200a, the host services 200b, and/or the host applications 200c may be not be running. Furthermore, the storage access service may be utilized to retrieve data corresponding to the host OS 200a, the host services 200b, and/or the host applications 200c when the host execution environment 200 is corrupted, shutdown, or unavailable.

The multimedia service may be used to run multimedia applications in the secondary execution environment 202 independently from the host execution environment 200. Exemplary multimedia applications may comprise voice over IP (VoIP), instant messaging (IM), audio streaming, and audio/video streaming based applications. By running the multimedia applications in the secondary execution environment 202, these applications are always available. Furthermore, the secondary execution environment 202 may be coupled with underlying hardware devices and/or resources, such as the I/O subsystem 104, to provide multimedia applications with better QoS than the QoS provided to the multimedia applications running in the host execution environment 200.

The network proxy service may enable utilizing the secondary execution environment 202 as a network proxy for other components in the computer system 100, such as the host execution environment 200 and/or any physical or logical entities therein. In this regard, the network proxy service may respond to network traffic on behalf of the host execution environment 200, when the host execution environment 200 is shutdown or becomes offline. For example, in instances where the host execution environment 200 transitions to a power-saving state or low-power state, the network proxy service may respond to Address Resolution Protocol (ARP) requests and/or Internet Control Message Protocol (ICMP) echo requests, without requiring the host execution environment 200 to transition back to active states for example.

The location service may be used to track a location of the computer system 100, such as in instances where location applications and/or services running in the host execution environment are unavailable for example. The location service may provide location information based on network or geographical location of the computer system 100. The host execution environment 200 may utilize the location service even in instances where it is in active states, and may be unaware of the fact that the location service is running on the secondary execution environment 202. The security service may provide various security applications, such as credential management, security offload, and/or network quarantining, to the host applications 200c, for example. In this regard, credential management may be utilized to authenticate users, devices, and/or applications interacting with the host applications 200c, and/or to generate, maintain, and/or updated data used in these authentication operations. The credentials and network security policies for the host applications 200c may be managed independently from the host execution environment 200.

The secondary execution environment 202, or any portions thereof, may be inactive in certain condition, such as when the host execution environment 200, or any components thereof such as the host OS 200a, are available, such as when the host OS 200a is operating normally and/or in an active state. The secondary processor 130a may be used to run the secondary OS 202a, which may be utilized to run the secondary applications 202c and/or the secondary services 202b. In this regard, particular secondary applications 202c may be run and/or executed only when needed, such as when corresponding host applications 200c are not available. Similarly, particular secondary services 202b may be run and/or executed when needed, such as when the host execution environment 200 becomes unavailable so that corresponding services may not be available, and/or when running the secondary applications 202b ensures that the computer system 100 remains secure and/or accessible (e.g. security service or the network proxy service) and/or that the host execution environment 200 may be reactivated properly and/or prompts (e.g. the application synchronization service and/or the location service).

FIG. 2B is a block diagram illustrating an exemplary computer system that may support secondary processing servicing of a host environment comprising a plurality of virtual machines, in accordance with an embodiment of the invention. Referring to FIG. 2B, there is shown the computer system 100 of FIG. 1.

The computer system 100 may be configured as virtualization based dual execution environment system, comprising the secondary execution environment 202 and a virtualized host execution environment 220, wherein each of the secondary execution environment 202 and the host execution environment 220 may run independent from the other. In this regard, the host execution environment 220 may be setup and/or configured in the host 110, using the host processor 110a and/or the host memory 110b for example. The storage subsystem 102, the I/O subsystem 104, and the network access subsystem 120 may be accessed, used, and/or shared by the host execution environment 220 and the secondary execution environment 202, substantially as described with regard to the secondary execution environment 202 and the host execution environment 200 in FIG. 2A.

The host execution environment 220 may be configured as a virtual environment comprising, for example, a plurality of virtual machines (VMs) 224 and a hypervisor (HV) 222. Each of the plurality of VMs 224 may comprise a software environment that may run, execute, and/or perform programs, applications, services, and/or processes. In this regard, each of the plurality of VMs 224 may essentially function as a separate instance of an operating system (OS), similar to the host OS 200a substantially as described with regard to FIG. 2A. For example, the VM 224 may comprise a guest operating system (GOS) 224a, which may enable performing, running and/or executing of various guest services 224b and/or guest applications 224c, independently in the host execution environment 220 of the computer system 100. Use of virtualization in systems, such as the computer system 100, may be desirable because it may enable maintaining the level of protection provided when operations are not consolidated under a single operating system while also enabling the optimization of the usage of resources available in the system.

The hypervisor (HV) 222 may comprise suitable logic, code, interfaces, and/or circuitry that may be utilized in a virtualized environment to support one or more virtual machines (VMs) that may run concurrently on a single physical platform. In this regard, the hypervisor 222 may correspond to and/or be implemented by various physical and/or virtual components and/or subsystems within the computer system 100. The hypervisor 222 may operate as a software layer that may run directly on top of resources in the computer system 100, such as the storage subsystem 102, the I/O subsystem 104, and/or the network access subsystem 120, to enable virtualization of the hardware and/or physical resources of the computer system 100.

In operation, the secondary execution environment 202 may be utilized to provide secondary processing servicing in the computer system 100, substantially as described with regard to FIG. 2A, in instances when the computer system 100 is configured as a virtualized platform. In this regard, the secondary applications 202c and/or secondary services 202b may be provided and/or performed in similar manner as described above, such as when the host execution environment 220 becomes unavailable. Use of virtualization, however, may necessitate additional functionality and/or controls to account for the existence of multiple VMs 224 running in the computer system 100. In this regard, applications and/or services provided by the secondary execution environment 202 may be configured, managed and/or controlled in a manner that may ensure each VM 224 running in the host execution environment 220 may be serviced separately and/or independently from other VMs. This may be done directly in the secondary execution environment 202, based on awareness of the virtualization. Alternatively, the secondary execution environment 202 may be unaware of the virtualization, and may simply handle tasks requested as if they are associated with a single dedicated component in the computer system 100 handling any necessary mapping between requested tasks and corresponding particular VMs 224 in the host execution environment 220.

The secondary processor 130a may incorporate, for example, a virtualization servicing management module 230, which may be utilized in scheduling tasks required, and/or in determining priority of what task to handle. In this regard, priority may be determined based on the task and/or on per-VM basis. Priority and/or scheduling operations may be based on preconfigured and/or predetermined data, and/or based on input provided by system users. For example, the virtualization servicing management module 230 may spawn multiple instances of a particular one of the secondary applications 202c when corresponding guest applications 222c in multiple VMs 224 become unavailable. This may occur, for example, when GOSs 222a running in these VMs 224 become unavailable, due to error and/or transition to inactive states, such as low-power or power-saving states for example. Similarly, the virtualization servicing management module 230 may spawn multiple instances of a particular one of the secondary services 202b when corresponding guest services 222b in multiple VMs 224 become unavailable. For some secondary services 202b, however, a single instance may be sufficient to service the VMs 224 running in the host execution environment 220. For example, a single instance of the multimedia service, the location service or the security service may be sufficient since these services are provided to the computer system 100 as a whole and/or provide information that may not be specific to any particular VM 224.

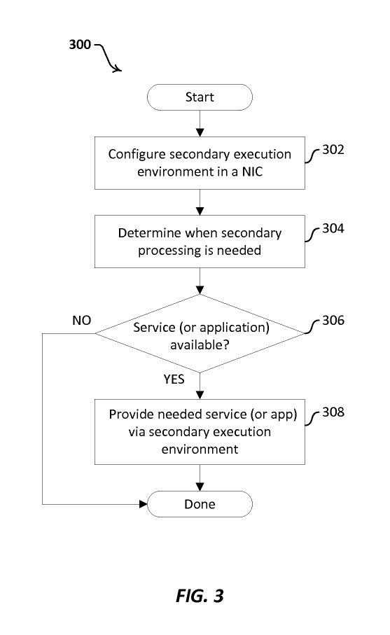

FIG. 3 is a flow chart that illustrates exemplary steps for providing host-independent secondary processing via a network controller, in accordance with an embodiment of the invention. Referring to FIG. 3, there is shown a flow chart 300 comprising a plurality of exemplary steps that may be performed to enable performing host-independent secondary processing in a system.

In step 302, a secondary execution environment may be configured in a network controller (NIC). For example, the secondary execution environment 202 may be configured in the network access subsystem 120, using the secondary processing component 130 for example. In step 304, the need for secondary processing may be determined. For example, the need for running and/or executing one or more of the secondary applications 202c and/or the secondary services 202b in the computer system 100 may be determined. This determination may be made based on monitoring of the status and/or system state of the computer system 100 and/or of the host execution environment 200, and/or the host execution environment 220. For example, transitions of the host OS 200a, or one or more GOS 222a in the VMs 224, to inactive states (e.g. low-power states) may necessitate triggering running and/or execution of one or more secondary applications 202c and/or the secondary services 202b.

In step 306, a determination whether a required service (or application) is available via secondary processing may be determined. In instances where the required service (or application) is not available via the secondary execution environment, the plurality of exemplary steps may terminate. In instances where the required service (or application) is available via the secondary execution environment, the plurality of exemplary steps may proceed to step 308. In step 308, the required service (or application) may be run or executed via the secondary execution environment. For example, the required secondary service 202b and/or secondary application 202c may be run and/or executed in the secondary execution environment 202, to enable servicing of the computer system 100, and/or corresponding host application 200c and/or host service 200b in the host execution environment 200.

Various embodiments of the invention may comprise a method and system for a host independent secondary application processor. The network access subsystem 120 in the computer system 100 may provide, using the secondary processing component 130 for example, the host-independent secondary execution environment 202. The secondary processing environment 202 may be provided by the network access subsystem 120 independent of networking operations performed by network access subsystem 120, and may comprise performing applications and/or services typically performed in the computer system 100, via the host environments 200 or 220 for example. The computer system 100 may comprise a personal computer (PC), a server, a workstation, and/or a mobile computing device. The secondary processing component 130 in the network access subsystem 120 may be fixed or removable. The secondary execution environment 202 may enable running and/or executing, in the network access subsystem 120, the secondary applications 202c and/or the secondary services 202b, independently from and/or in lieu of availability of the host execution environment 200 (or the host execution environment 200) in the computer system 100. The secondary services 202b may comprise management services, application synchronization services, storage access services, multimedia services, network proxy services, location services, and/or security services. The secondary execution environment 202 may be provided when operating systems (OS), virtual machines (VMs), services, and/or applications running in host 110 in the computer system 100 become unavailable, which may result in error scenarios and/or from system, OS, and/or VM transitions to non-active and/or low-power states.

The secondary execution environment 202 may be activated when the corresponding OS (e.g. the host OS 200a), VMs (e.g. VMs 224), services (e.g. host services 200b and/or guest services 220b), and/or applications (e.g. host applications 200c and/or guest applications 220c) become unavailable. In instances where the computer system 100 is configured as a virtualized platform, which may comprise concurrently running of plurality of VMs 224, the secondary execution environment 202 may be provided separately and/or independently to each of the VMs 224 running in the computer system 100 during the virtualization. This may be done with and/or without awareness by the secondary execution environment 202 of the virtualization. In instances where the secondary execution environment 202 operates based on awareness of the virtualization, tasks may be scheduled and/or managed on a per-VM basis, using the virtualization servicing managing module 230.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for host independent secondary application processor.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
performing by a network interface controller (NIC) in a host device, secondary processing servicing within said host device, wherein:
said network interface controller (NIC) provides said secondary processing servicing independent of operations of said host device;
said network interface controller (NIC) provides said secondary processing servicing independent of networking operations performed by said network interface controller (NIC); and
said network interface controller (NIC) is operable to perform via secondary processing servicing applications and/or services that are provided in said host device.

2. The method according to claim 1, comprising providing said secondary processing servicing when an operating system (OS), a virtual machine (VM), a service, and/or an application running in said host device becomes unavailable.

3. The method according to claim 2, wherein said unavailability of said operating system (OS), virtual machine (VM), service, and/or application results from transition to power-saving or low-power states.

4. The method according to claim 2, comprising activating said secondary processing servicing when said operating system (OS), virtual machine (VM), service, and/or application becomes unavailable.

5. The method according to claim 1, wherein said host device comprises a personal computer (PC), a server, a workstation, and/or a mobile computing device.

6. The method according to claim 1, wherein said host device is configured as a virtualized platform.

7. The method according to claim 5, comprising providing said secondary processing servicing separately and/or independently to each of a plurality of virtual machines running in said host device during said virtualization.

8. The method according to claim 1, wherein said secondary processing servicing comprises providing management services, application synchronization services, storage access services, multimedia services, network proxy services, location services, and/or security services.

9. The method according to claim 1, comprising providing said secondary processing servicing using a dedicated component in said network interface controller (NIC).

10. The method according to claim 9, wherein said dedicated component is removable or fixed.

11. A system comprising:
one or more circuits and/or processors for use in network interface controller (NIC) of a host device, said one or more circuits and/or processors being operable to perform secondary processing servicing within said host device, wherein:
said network interface controller (NIC) provides said secondary processing servicing independent of operations of said host device;
said network interface controller (NIC) provides said secondary processing servicing independent of networking operations performed by said network interface controller (NIC); and
said network interface controller (NIC) is operable to perform via secondary processing servicing applications and/or services that are provided in said host device.

12. The system according to claim 11, wherein said one or more circuits and/or processors are operable to provide said secondary processing servicing when an operating system (OS), a virtual machine (VM), a service, and/or an application running in said host device becomes unavailable.

13. The system according to claim 12, wherein said unavailability of said corresponding operating system (OS), virtual machine (VM), service, and/or application results from transition to power-saving or low-power states.

14. The system according to claim 12, wherein said one or more circuits and/or processors are operable to activate said secondary processing servicing when said operating system (OS), virtual machine (VM), service, and/or application becomes unavailable.

15. The system according to claim 11, wherein said host device comprises a personal computer (PC), a server, a workstation, and/or a mobile computing device.

16. The system according to claim 11, wherein said host device is configured as a virtualized platform.

17. The system according to claim 15, wherein said one or more circuits and/or processors are operable to provide said secondary processing servicing separately and/or independently to each of a plurality of virtual machines running in said host device during said virtualization.

18. The system according to claim 11, wherein said secondary processing servicing comprises providing management services, application synchronization services, storage access services, multimedia services, network proxy services, location services, and/or security services.

19. The system according to claim 11, wherein said network interface controller (NIC) comprises a dedicated component for providing said secondary processing servicing.

20. The system according to claim 19, wherein said dedicated component is removable or fixed.
